(19) United States
(12) Patent Application Publication
(10) Pub. No.: US 2002/0190092 A1
(43) Pub. Date: Dec. 19, 2002

(54) Method for manufacturing a protective cover for a breaking apparatus, and a breaking apparatus

(76) Inventor: Timo Salmi, Lahti (FI)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/173,873

(22) Filed: Jun. 19, 2002

(30) Foreign Application Priority Data
Jun. 19, 2001 (FI) 20011299

(51) Int. Cl. B26F 3/00

(52) U.S. Cl. 225/103; 225/93; 225/2

(57) ABSTRACT

A method for manufacturing a protective cover for a breaking apparatus, and a breaking apparatus provided with such a protective cover. The protective cover is formed of two elongated cover parts having a substantially L-shaped cross section; the longitudinal edge portions of the cover parts are arranged together, thus forming a tubular structure having a substantially rectangular cross section. Adjusting the mutual position of the L-shaped cover parts enables to adjust the dimensions of the cross section of the protective cover still during assembly.

### FIELD OF THE INVENTION

The invention relates to a method for manufacturing a protective cover for a breaking apparatus, the breaking apparatus comprising a percussion device having a percussion piston arranged to make reciprocating motion in the axial direction and to strike a strike-receiving surface of a tool on the axial extension of the percussion piston for providing an impact impulse in the tool, whereby the tool transmits the impact impulse further to a target to be treated, the breaking apparatus also comprising a protective cover, within which the percussion device is arranged, and the method comprising the following steps: forming two elongated cover parts, arranging longitudinal edge portions of the cover parts substantially against each other in order to achieve a tubular structure having a substantially rectangular cross section, arranging a transverse upper piece at the upper end of the protective cover, and also arranging a transverse lower piece at the lower end of the protective cover, through which the tool is directed.

The invention also relates to a breaking apparatus comprising a percussion device having a percussion piston arranged to make reciprocating motion in the axial direction and to strike a strike-receiving surface of a tool on the axial extension of the percussion piston for providing an impact impulse in the tool, whereby the tool transmits the impact impulse further to a target to be treated, the breaking apparatus also comprising a protective cover, within which the percussion device is arranged, and the protective cover is formed of two elongated cover parts comprising longitudinal edges, and the cover parts are fastened together from the longitudinal edges thereof to form a tubular structure having a substantially rectangular cross section, and the protective cover also comprises a transverse upper piece at the upper end of the protective cover and correspondingly a transverse lower piece at the lower end of the protective cover, through which the tool is arranged.

### BACKGROUND OF THE INVENTION

Breaking apparatuses, or percussion hammers, are used for breaking stone, concrete, asphalt, frozen ground, metal slag and other relatively hard materials. Conventionally, the percussion hammers are mounted to replace excavator buckets, and consequently they are operated by excavator hydraulics. Other basic machines and carriers can be used as well. The breaking apparatus comprises a percussion device, to which a tool is attached. When the apparatus is in operation, a percussion piston of the percussion device moves to and fro by impact of pressure medium, strikes a strike-receiving surface of the tool and provides an impact impulse in the tool. The tool is simultaneously pressed against the target to be treated, whereby the tool penetrates, by the effect of the impact, into the material to be treated and makes the material break or cut, depending on the shape of the tool.

The structure of a breaking apparatus generally comprises a protective cover, within which the percussion device is arranged. The primary object of a protective cover is to protect the percussion device from dents and impurities. A known protective cover comprises two elongated halves having U-shaped cross-sections and bent of plate material. In this assembly the longitudinal edges of the halves are arranged end to end against each other and joined with a welded joint to form a uniform tubular structure. However, regarding the bending of the halves as well as the assembly of the halves, inaccuracies always occur to some extent, causing variation to the accuracy of the dimensions and form of the protective cover. The protective cover must therefore be machined after assembly, so that the mounting faces, which are accurate enough, are provided inside the protective cover for mounting the percussion device. Furthermore, the plate materials of the halves must be dimensioned to be fairly thick in order to be provided with the required allowance for machining. In brief, the protective cover is heavy and expensive to manufacture.

Another known protective cover is composed of four plate-like sideportions, which are rectangularly positioned and welded together from the longitudinal edges thereof to form a tubular structure. This solution comprises a number of welded joints and the assembly is difficult, and the protective cover is therefore slow and expensive to manufacture. In addition, since the structure is provided with several welded joints, dimensional and form errors caused by heat expansion are created thereto during assembly. Hence, this protective cover must also typically be machined after assembly.

In both solutions described above the protective cover must be machined after assembly, a fact that has to be taken into account already when the structure of the protective cover is designed. It is therefore typical to form the protective cover in the longitudinal direction of two parts, i.e. of an upper and a lower part, into which parts the required mounting faces are easier to machine. After machining, the upper and lower parts are joined together using a transverse welded joint in the protective cover. Such a structure comprises a particularly large number of welded joints and working stages, and is therefore laborious and expensive to manufacture. Furthermore, a protective cover comprising several joints is liable to shredding.

### BRIEF DESCRIPTION OF THE INVENTION

It is an object of the invention to provide a new and improved solution for a protective cover of a breaking apparatus.

The method of the invention is characterized by forming two cover parts having a substantially L-shaped cross section, adjusting the mutual position of the cover parts in the transverse direction in order to achieve the designed inner dimensions of the protective cover and fastening the cover parts within the area of the longitudinal edges immovably to one another after the adjusting measures have been taken.

The breaking apparatus of the invention is characterized in that the cross section of the cover parts is substantially L-shaped.

An essential idea of the invention is that the protective cover is formed of two elongated cover parts having a substantially L-shaped cross section, which are joined together to form a tubular structure having a rectangular cross section. The form and dimensions of the protective cover in cross section can be adjusted during assembly by moving the cover parts transversely in relation to one another. The L-shaped cover parts allow adjusting the cross section of the protective cover in two directions perpendicular to one another, i.e. in the vertical and horizontal direction of the rectangle. After adjusting the designed dimensions and form to the cross section of the protective cover, the cover parts are immovably joined together, for example by welding.

An advantage with the method of the invention is that in order to ensure the cross sectional dimensions of the protective cover, the protective cover does no longer have to be machined after assembly, instead the cross section profile of the protective cover, i.e. the dimensions and form, can already during assembly be adjusted to be accurate enough. The possible inaccuracies that have occurred during the manufacture of the cover parts can thus be compensated. Since an expensive machining stage is left out, the manufacturing costs of the protective cover are lower than before. In addition, the protective cover can be designed more freely than before, as the machining stage after assembly need not be taken into account in the structure of the protective cover. Another advantage is that the protective cover can be made of a thinner plate material than before, which also makes the protective cover easier to manufacture as well as lighter. The L-shape of the cover parts in the protective cover according to the invention allows the welded joints to be placed in the comers of the protective cover, whereby each side of the protective cover is uniform and even. Furthermore, as the joints are placed in the stiff corners of the protective cover, they resist wear far better than the covers formed of U-shaped cover parts, in which the joints are placed in the middle of the cover side.

An essential idea of an embodiment of the invention is that at least one of the longitudinal joint edges of the cover parts arranged against one another is bevelled.

### BRIEF DESCRIPTION OF THE DRAWINGS

The invention is explained in greater detail in the accompanying drawings, in which

FIG. 1 schematically shows a side view cut open of a percussion hammer according to the invention,

FIG. 2 schematically shows in perspective a protective cover according to the invention,

FIG. 3 schematically shows from direction B the protective cover shown in FIG. 2,

FIGS. 4 to 7 schematically show a first embodiment of the invention in cross section,

FIGS. 8 and 9 schematically show a second embodiment of the invention in cross section,

FIGS. 10 to 13 schematically show a third embodiment of the invention in cross section, and

FIG. 14 schematically shows a side view of another percussion hammer.

For clarity, the Figures show a simplified view of the invention. The same reference numerals are used for similar parts.

### DETAILED DESCRIPTION OF THE INVENTION

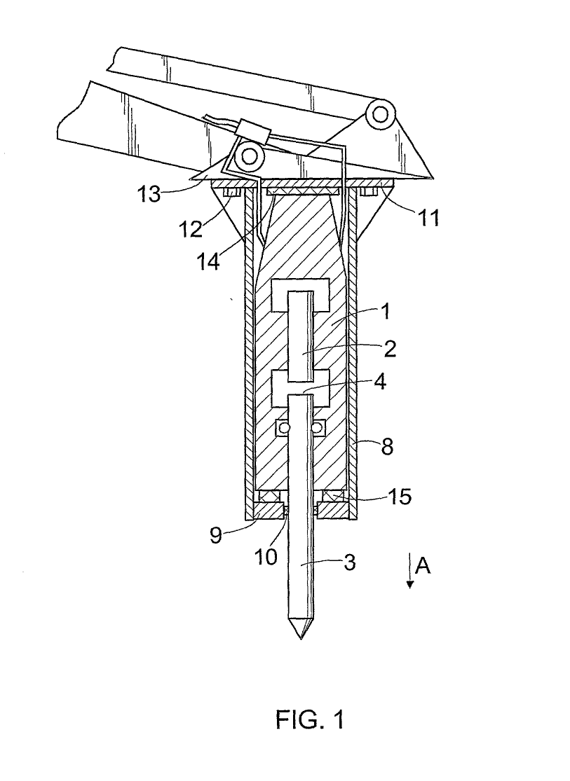

FIG. 1 shows a simplified view of a percussion hammer according to the invention. A percussion device 1 comprises a percussion piston 2 arranged to move to and fro in the axial direction. Typically the pressure of hydraulic fluid affects the percussion piston 2, but pneumatic and electric uses are also possible. The structure and operation of the percussion device 1 are as such known to those skilled in the art, wherefore a more detailed description thereof is not necessary in this context. A tool 3 is positioned as an extension of the percussion piston 2 in stroke direction A. The tool 3 has a strike-receiving surface, on which the front end of the percussion piston 2 strikes. It should be noted that in this application a reference to the front and bottom ends of the percussion hammer refers to the end, where the tool is located. Furthermore, a protective cover 8 is arranged around the percussion device 1 that protects the percussion device 1 from impurities and dents. The bottom end of the protective cover 8 comprises a transverse lower piece 9, through which the tool 3 penetrates. A seal 10 preventing impurities from entering inside the protective cover 8 is placed between the lower piece 9 and the tool 3. The protective cover 8 also comprises a transverse upper piece 11, which can be fastened to the upper end of the protective cover 8 by welding. The upper piece 11 may comprise holes from which said piece could be fastened using fastening bolts 12 or other appropriate fastening elements to a fastening part 13 in an excavator boom. A first damping element 14 can be placed between the percussion device 1 and the upper piece 11 and correspondingly a second damping element 15 can be placed between the percussion device 1 and the lower piece 9, whereby the percussion device 1 is supported by the elements 14 and 15 inside the protective cover 8. The percussion device 1 is able to move slightly in the axial direction during operation supported by the damping elements 14, 15. In addition to the guiding operation the damping elements 14 and 15 also damp vibration and noise. The sides of the protective cover 8 locate the percussion device 1 accurately in the transverse direction of the protective cover 8 to a pre-designed position. For this reason, the cross section profile of the protective cover 8 must be made fairly accurate.

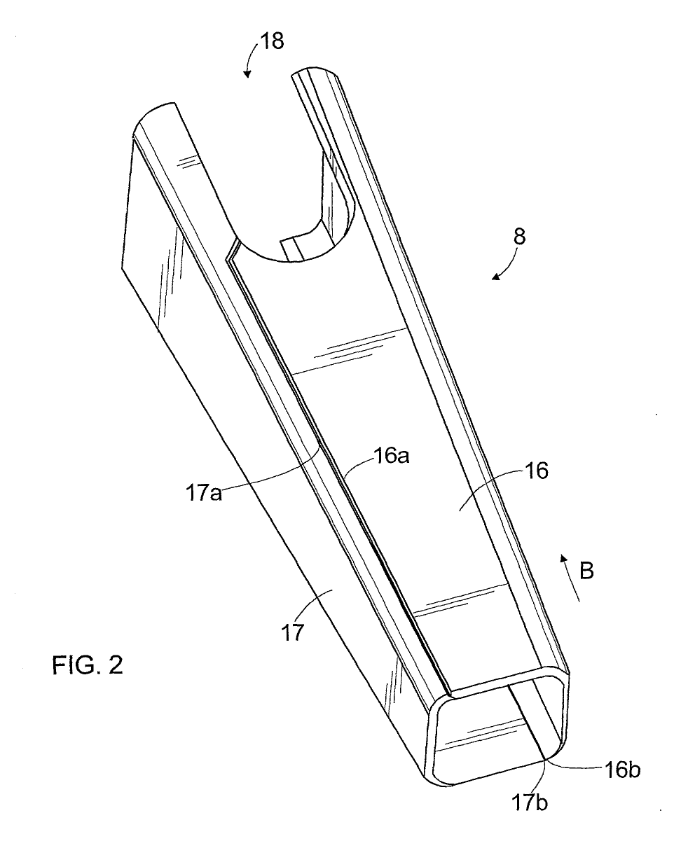

FIGS. 2 and 3 illustrate the protective cover 8 without the upper piece 11 and the lower piece 9. The protective cover 8 is formed of two substantially L-shaped cover parts 16 and 17, whose longitudinal edges 16a and 17a and correspondingly 16b and 17b are arranged opposite to one another or at least nearly opposite each other. Thus, a tube that is substantially rectangular in cross section is formed. Selecting the side dimensions of the L-shaped cover parts 16, 17 appropriately, the cross section of the protective cover 8 may substantially resemble either a square or a rectangle. In addition the cross section of the cover parts 16, 17 may substantially be constant along the length of the protective cover 8. Alternatively, the cross section of the cover parts 16, 17 may increase towards the back end of the protective cover 8, in which case the assembled protective cover 8 is wedge-shaped as shown in FIGS. 2, 3 and 14. The cover parts can be made of plate material and an L-shaped cross section profile is formed thereto using longitudinal bending. Furthermore, the longitudinal edges 16a, 16b, 17a, 17b can be provided with an appropriate welding bevel in order to alleviate the welded joints between the cover parts 16, 17. The upper end of the protective cover 8 according to FIGS. 2 and 3 comprises on the opposite sides thereof U-shaped cuts 18, upon which the percussion device 1 rests. For clarity, the possible openings and through holes of the protective cover are not shown in FIGS. 2 and 3.

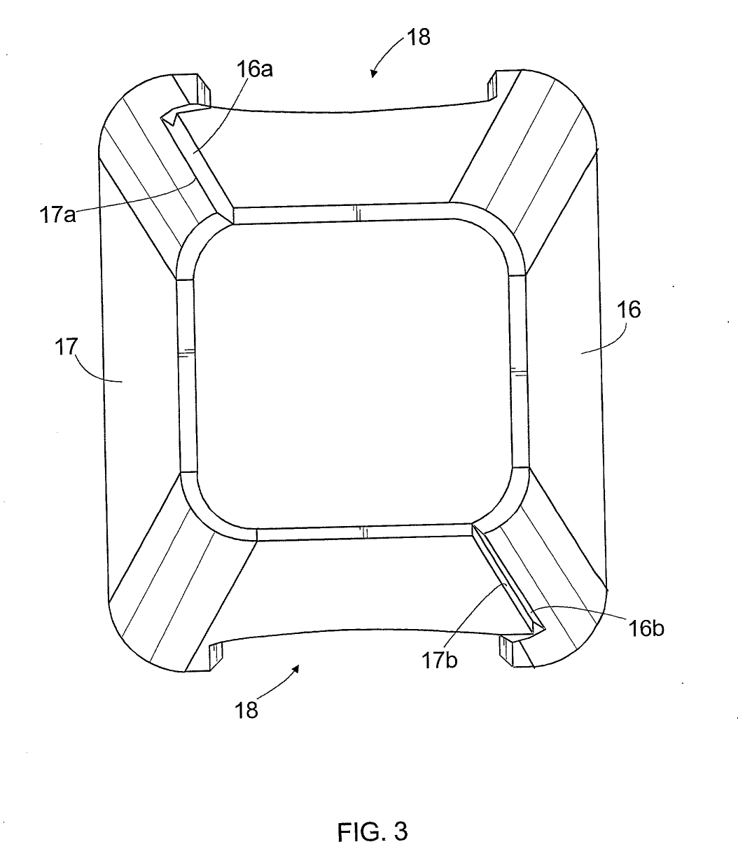

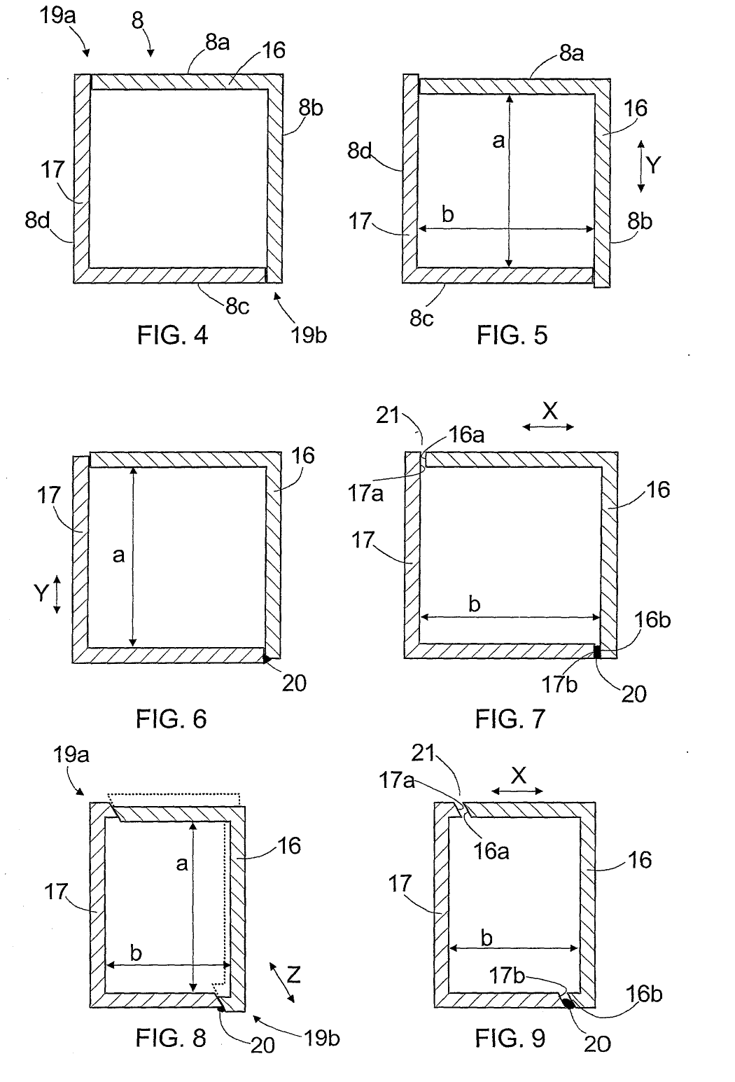

FIG. 4 illustrates a cross section of the protective cover 8 according to the invention. The protective cover 8 is assembled of two cover parts 16, 17 having an L-shaped cross section. The first cover part 16 then comprises two sides 8a, 8b of the protective cover and correspondingly the second cover part 17 comprises sides 8c, 8d. On account of their cross sectional form the longitudinal joints between the cover parts 16, 17 are located in opposite corners 19a and 19b of the cross section of the protective cover 8. The joints thus endure heavy loads, since the corners 19a and 19b are relatively stiff. No bucklings occur in the corners.

FIGS. 5, 6 and 7 show that the dimensions and form of the protective cover's 8 cross section can conveniently be adjusted during assembly. In practice, the assembly is carried out so that the cover parts 16 and 17 are arranged into an appropriate fastener, which positions the cover parts 16 and 17 in relation to one another in such a manner that the predesigned dimensions and form of the cross section are achieved. In FIG. 5 the cover parts 16 and 17 are adjusted in relation to each other in the vertical direction Y so that distance a between the first horizontal side 8a and the second horizontal side 8c is at a minimum. Distance b between the vertical sides 8b and 8d can be kept unchanged, when dimension a is adjusted. In FIG. 6, the vertical dimension a is at a maximum. The adjustment margin inside and outside may vary about ⅓ of the plate thickness of the protective cover, which normally is fully adequate to compensate for possible inaccuracies in the cover portion structure. In FIG. 7, in turn, the horizontal dimension b of the protective cover is adjusted, whereby an root gap 21 of the size of the adjustment margin that a welded joint 20 tightly fills remains between the joint edges 16a and 17a of the cover parts 16 and 17 and also between 16b and 17b. The breadth of the root gap 21 may, if required, be about 1 to 2 mm, however, it generally remains smaller than ⅓ of the plate thickness of the protective cover. The welded joint 20 may be extended uniformly from the lower end of the protective cover 8 to the upper end thereof.

The longitudinal opposite edges 16a and 17a and correspondingly 16b and 17b of the cover parts 16 and 17 in the protective cover 8 shown in FIG. 8 are bevelled in parallel, whereby the vertical dimension a as well as the horizontal dimension b simultaneously change when the cover parts are moved along the bevelled edge surface in direction Z. A dashed line in FIG. 8 indicates another extreme position. In FIG. 9, the cover parts 16 and 17 are adjusted only in the horizontal direction X, whereby the root gap 21 that the welded joint 20 fills is formed between the edges 16a and 17a as well as between 16b and 17b.

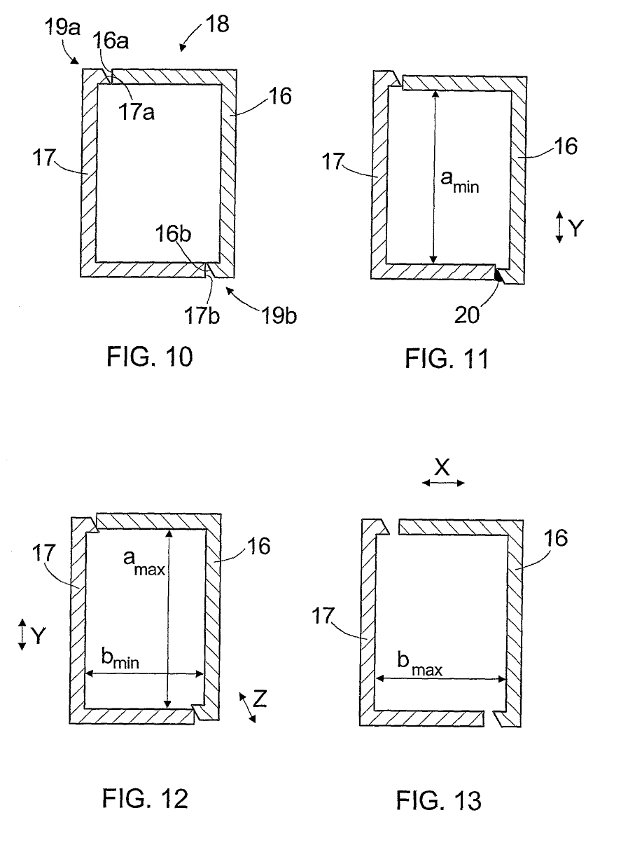

In FIG. 10, one of the longitudinal opposite edges 16a or 17a and correspondingly 16b or 17b of the cover parts 16 and 17 in the protective cover 8 are bevelled and the other edge remains straight. In such a case, the cover parts 16 and 17 can be moved in relation to one another as shown in FIG. 11 merely in the vertical direction Y, and the vertical dimension a can be adjusted or only the horizontal dimension b can be adjusted as shown in FIG. 13 using horizontal adjustment movement X. It is also possible to move the cover parts as shown in FIG. 12 in direction Z, whereby dimensions a and b are adjusted simultaneously.

In FIGS. 8 and 12 the longitudinal edges 16a and 17a and correspondingly 16b and 17b partly overlap one another.

In FIGS. 4 to 13 the corners of the cover parts 16 and 17 are shown for the sake of simplicity as sharp ones, but in reality the corners can be slightly arched owing to the bending.

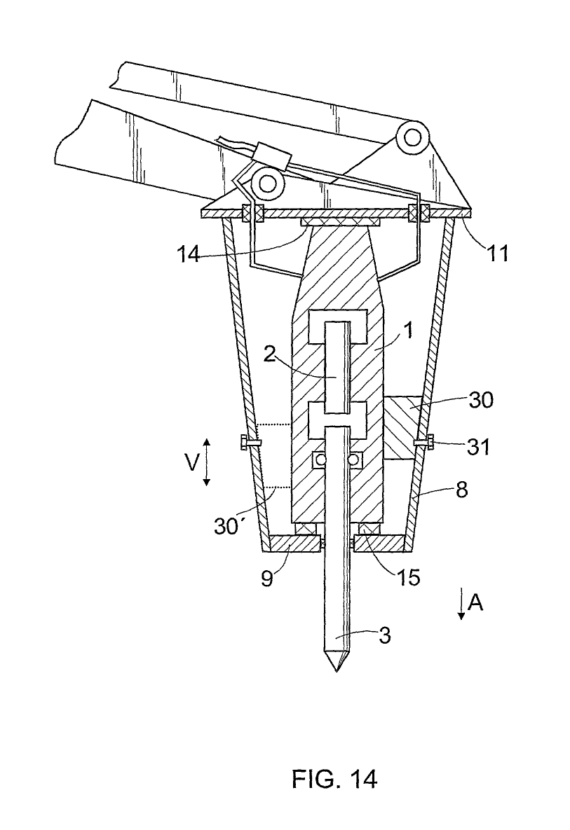

FIG. 14 shows another percussion hammer in cross cut. The solution of the invention allows manufacturing a wedge-shaped protective cover 8 tapering towards the lower end thereof. Thus, a wedge-shaped wear part 30 can be arranged into the wedge-shaped space formed between the inner surface of the protective cover 8 and the outer surface of the percussion device 1. Preferably the number of wear parts 30 is at least two and arranged on the opposite sides of the percussion device 1. During the operation of the device, the percussion device 1 is able to move slightly inside the protective cover 8 in the axial direction supported by the damping elements 14 and 15. The wear parts 30 thus support and guide the motion of the percussion device 1 body. The percussion device 1 slides, when the percussion hammer is used, in relation to the wear parts 30, wherefore the wear parts wear with time. In the solution shown in FIG. 14, the position of the wedge-shaped wear parts 30 can, however, conveniently, for instance when services are carried out, be adjusted in the vertical direction V in the wedge-shaped space between the protective cover and the percussion device, whereby the required support can be achieved also with worn wear parts 30. Such an adjustment allows employing the wear parts 30 considerably longer. In addition, the clearance between the wear parts 30 and the percussion device 1 body can be adjusted as desired. The wear parts 30 may comprise a fastening groove or the like on the surface at the protective cover 8 side, to which an adjustment screw 31 can be arranged so that the wear part can, if necessary, be moved in the vertical direction V. The adjustment of the wear parts 30 can be carried out outside the protective cover 8. A wear part 30′ is indicated by a dashed line in FIG. 14 that has worn in use and whose position is readjusted so that it is again able to provide the percussion device with the required support and guidance. The wear parts thus keep the percussion device in a predetermined position inside the protective cover and also prevent vibration and noise from being created. The wear parts can be made of for instance an appropriate plastic material that endures wear.

The drawings and the specification associated therewith are merely intended to illustrate the idea of the invention. The details of the invention may vary within the scope of the claims.

What is claimed is:

1. A method for manufacturing a protective cover for a breaking apparatus, the breaking apparatus comprising a percussion device having a percussion piston arranged to make reciprocating motion in the axial direction and to strike a strike-receiving surface of a tool on the axial extension of the percussion piston for providing an impact impulse in the tool, whereby the tool transmits the impact impulse further to a target to be treated, the breaking apparatus also comprising a protective cover, within which the percussion device is arranged, and the method comprising:
forming two elongated cover parts having a substantially L-shaped cross section;
arranging longitudinal edge portions of the cover parts substantially against each other in order to achieve a tubular structure having a substantially rectangular cross section;
adjusting the mutual position of the cover parts in the transverse direction in order to achieve the designed inner dimensions of the protective cover;
fastening the cover parts within the area of the longitudinal edges immovably to one another after the adjusting measures have been taken, and
arranging a transverse upper piece at the upper end of the protective cover, and also arranging a transverse lower piece at the lower end of the protective cover, through which the tool is directed.

2. A method as claimed in claim 1, comprising forming the cover parts of plate material and bending the cover parts into L-shape using longitudinal bending.

3. A method as claimed in claim 1, comprising fastening the cover parts together at the longitudinal edges using substantially uniform welded joints extending substantially from the lower edge to the upper edge of the protective cover.

4. A method as claimed in claim 1, comprising arranging at least some of the opposite longitudinal edges of the cover parts so as to at least partly overlap one another.

5. A breaking apparatus comprising a percussion device having a percussion piston arranged to make reciprocating motion in the axial direction and to strike a strike-receiving surface of a tool on the axial extension of the percussion piston for providing an impact impulse in the tool, whereby the tool transmits the impact impulse further to a target to be treated,
the breaking apparatus also comprising a protective cover, within which the percussion device is arranged,
and the protective cover is formed of two elongated cover parts comprising longitudinal edges, and the cross section of the cover parts being substantially L-shaped,
and the cover parts are fastened together from the longitudinal edges thereof to form a tubular structure having a substantially rectangular cross section,
and the protective cover also comprises a transverse upper piece at the upper end of the protective cover and correspondingly a transverse lower piece at the lower end of the protective cover, through which the tool is arranged.

6. A breaking apparatus as claimed in claim 5, wherein the cover parts are fastened together using a substantially uniform welded joint extending substantially from the lower edge of the protective cover to the upper edge thereof.

7. A breaking apparatus as claimed in claim 5, wherein the cover parts are made of plate material by bending.
